(19) United States
(12) Patent Application Publication
(10) Pub. No.: US 2002/0085701 A1
(43) Pub. Date: Jul. 4, 2002

(54) Method and system for providing unified communication management based on presence information

(76) Inventors: Eric W. Parsons, Ashton (CA); Steven M. Armstrong, Nepean (CA); Helene Saint-Amour, Ottawa (CA); Gerald R. Suggitt, Richmond Hill (CA); Hans Bergman, Kanata (CA)

Correspondence Address: PILLSBURY MADISON & SUTRO LLP, 1100 New York Avenue, N.W., Ninth Floor, East Tower, Washington, DC, 20005-3918, US

(21) Appl. No.: 09/753,340

(22) Filed: Dec. 29, 2000

Related U.S. Application Data
(60) Provisional application No. 60/244,233, filed on Oct. 30, 2000.

(51) Int. Cl. H04M 3/42

(52) U.S. Cl. 379/211.01; 379/201.02

(57) ABSTRACT

In accordance with a method and apparatus for providing unified communications and messaging management based on a user's presence information, a presence system is coupled to a PBX, a voice mail service and a LAN in an office. The presence system keeps track, in a secure manner, of registered users' current “presence context” (e.g. at desk, campus roam, at hotel, at home, etc.). When a call to a user is received by the PBX, the presence system forwards the call to the user in accordance with the user's current presence context. An IVR system may be provided to make communication and messaging options available to the caller, which options depend on the user's current presence context. The presence system further provides registered users with the ability to configure the number and type of communications and message devices with which they can be accessed and to define different “profiles” that define the communications and messaging options presented to incoming callers in each presence context. The presence system may further allow a user to specify whether certain of the user's configured devices are temporarily unavailable so that the device can be temporarily removed from a set of options presented to an incoming caller.

### CROSS-REFERENCE TO RELATED APPLICATIONS

The present application is based on, and claims priority from, U.S. application Ser. No. 60/244,233, entitled METHOD AND SYSTEM FOR PROVIDING UNIFIED COMMUNICATION MANAGEMENT BASED ON PRESENCE INFORMATION, filed Oct. 30, 2000, commonly owned by the present assignee, the contents of which are incorporated by reference.

The present application is related to co-pending U.S. applications No. ______ (NOR-13416RO) entitled METHOD AND APPARATUS FOR MANAGING COMMUNICATIONS BASED ON CALLER IDENTIFICATION AND CATEGORIZATION, No. ______ (NOR-13636RO) entitled METHOD AND SYSTEM FOR PROVIDING ENTERPRISE MESSAGE NOTIFICATION TO A REMOTE DEVICE WITH RESPONSE ENABLEMENT, No. ______ (NOR-13637RO) entitled METHOD AND SYSTEM FOR PROVIDING UNIFIED WAP ALERTS, No. ______ (NOR-13639RO) entitled METHOD AND SYSTEM FOR PROVIDING SELECTIVE ACCESS TO ENTERPRISE MESSAGES FROM A REMOTE DEVICE and No. ______ (NOR-13640RO) entitled METHOD AND SYSTEM FOR PROVIDING REMOTE ACCESS TO PREVIOUSLY TRANSMITTED ENTERPRISE MESSAGES, all filed Dec. 29, 2000 and commonly owned by the assignee of the present invention, the contents of each being fully incorporated herein by reference.

### FIELD OF THE INVENTION

This invention relates generally to managing communications and messaging, and more particularly, to a system and method for personalized management over the delivery of incoming calls and messages based on a user's presence information.

### BACKGROUND OF THE INVENTION

An emerging standard being defined by the Internet Engineering Task Force (IETF) is th e notion of presence and instant messaging. Although this framework is helpful at developing standard terms for defining presence and instant messaging ideas, by its design it does not suggest an actual application of these ideas in real-world communication and messaging systems.

Private Branch Exchanges (PBXs) and voice mail systems are ubiquitous in offices around the world. Their capabilities for dealing with user presence states are, however, rigidly fixed and quite limited. For example, a typical PBX system allows incoming calls to be automatically transferred to a voice mail service if the user does not answer within a fixed number of phone rings or if the user has manually indicated that he does not wish to be disturbed (e.g. by pressing a “busy” or “do not disturb” button on the PBX phone). Typical PBX systems further allow incoming calls to be automatically forwarded to another office phone by a manual entry (e.g. by selecting a “call forwarding” button on the PBX phone and pressing the number corresponding to the forwarded phone).

Meanwhile, the notion behind presence and instant messaging is that users have various general presence contexts (e.g. at the desk, away from the desk but in the office, or out of the office but accessible by other communications means), and they have general preferences about how to communicate with others during such general contexts. However, conventional PBX and voice mail systems do not provide means for tracking changes in user's presence contexts, nor do they allow users to define how calls or messages should be handled for such various presence contexts, nor do they allow incoming callers to select how to communicate with a user when they cannot be reached at their usual desk phone number.

Moreover, conventional PBX and voice mail systems are limited to providing communications and messages to users only within the PBX and voice mail systems themselves, while many users, especially highly mobile employees such as executives, sales people and service technicians, are generally more accessible through other forms of communication and text notification devices (e.g. cell phones (both with and without text messaging features), one-way and two-way pagers, PDAs with wireless access (e.g. Palm Pilot, RIM Blackberry), etc.). Further, the availability of these devices is sometimes quite variable (e.g. a cell phone battery might go dead). Accordingly, even if conventional PBX and voice mail systems could be enhanced to include more general presence context handling capabilities, they would still lack the ability to provide communications and messaging services to such highly mobile employees through such alternative and variably available devices.

### SUMMARY OF THE INVENTION

The present invention relates to a method and apparatus for personalized call and message management based on presence information.

In one example of the invention, a presence system is coupled to a PBX, a voice mail service and a LAN in an office. The presence system keeps track, in a secure manner, of registered users' current “presence context” (e.g. at desk, campus roam, at hotel, at home, at restaurant, etc.). When a call to a user is received by the PBX, the presence system forwards the call to the user in accordance with the user's current presence context. For example, when the user is “at desk,” the call may first be directed to the user's desk phone, and if there is no answer, the call may be directed to the user's cell phone. An IVR system may be provided to make communication and messaging options available to the caller, which options depend on the user's current presence context.

The presence system further provides registered users with the ability to configure the number and type of communications and message devices with which they can be accessed and to define different “profiles” that define the communications and messaging options presented to incoming callers in each presence context. Thus, by simply notifying the system of a change in the user's presence context, the user can easily switch from one profile to another. These profiles are completely customizable by an end-user, so he or she can shape the exact communication experience they prefer under various conditions (e.g. via office phone, home phone, or cell phone, via pager, or via voice mail). The presence system may further allow a user to specify whether certain of the user's configured devices are temporarily unavailable (e.g. a cell phone battery is dead) so that the device can be temporarily removed from a set of options presented to an incoming caller.

In accordance with one aspect of the invention, a method for managing communications with a user in a communication system includes maintaining presence information for the user, the presence information specifying one of a plurality of presence contexts, maintaining a presence context profile for the user, the presence context profile specifying a plurality of communication options for the plurality of presence contexts, and controlling communications with the user in accordance with the maintained presence information and the maintained presence context profile.

In accordance with another aspect of the invention, a method of managing communications with a user in a communication system comprises receiving an incoming call to the user, determining a current presence context of the user, determining a context profile corresponding to the current presence context for the user, the context profile specifying a plurality of communication options for the current presence context, and forwarding a communication associated with the incoming call to the user in accordance with the context profile.

In accordance with a further aspect of the invention, an apparatus for managing communications with users based on presence information includes a communication system adapted to provide communications among a plurality of communication devices, and a presence system adapted to be coupled to the communication system, the presence system maintaining a presence context and a context profile for certain users associated with the plurality of communication devices, the presence system causing the communication system to direct incoming calls to the certain users in accordance with the maintained presence context and context profile.

### BRIEF DESCRIPTION OF THE DRAWINGS

The present invention will become apparent to those ordinarily skilled in the art upon review of the following description of specific embodiments of the invention in conjunction with the accompanying figures, wherein:

FIG. 1 illustrates an example topology for an implementation of the present invention in accordance with one embodiment;

FIG. 2 illustrates an example of a presence system in accordance with an embodiment of the invention as illustrated in FIG. 1 in more detail;

FIG. 3 illustrates an example of the data structure of a presence context profile maintained in a context profile store for each user in accordance with one embodiment of the present invention;

FIGS. 4A to 4L are user interface screens that illustrate example methods for allowing a user to customize how their incoming calls should be handled in the various presence contexts, which methods can be used to implement the presence awareness clients and the context configuration clients in one embodiment of the present invention;

FIG. 5 is a flowchart illustrating an example method of handling an incoming call to a user based on the user's presence information in accordance with one embodiment of the present invention;

FIG. 6 is a flowchart illustrating an example method of forwarding a text message to a user based on the user's presence information in accordance with one embodiment of the present invention;

FIG. 7 illustrates another example of presence context configuration information maintained for each user in accordance with another embodiment of the present invention;

FIG. 8 is a user interface dialog box that illustrates processing for allowing a user to change the availability settings of devices in accordance with another embodiment of the present invention;

FIG. 9 is a flowchart illustrating an example method of handling an incoming call to a user based on the user's presence information and device availability information in accordance with another embodiment of the present invention; and

FIG. 10 is a flowchart illustrating an example method of forwarding a text message to a user based on the user's presence information and device availability in accordance with another embodiment of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the implementation of certain elements of the present invention may be accomplished using software, hardware or any combination thereof, as would be apparent to those of ordinary skill in the art, and the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

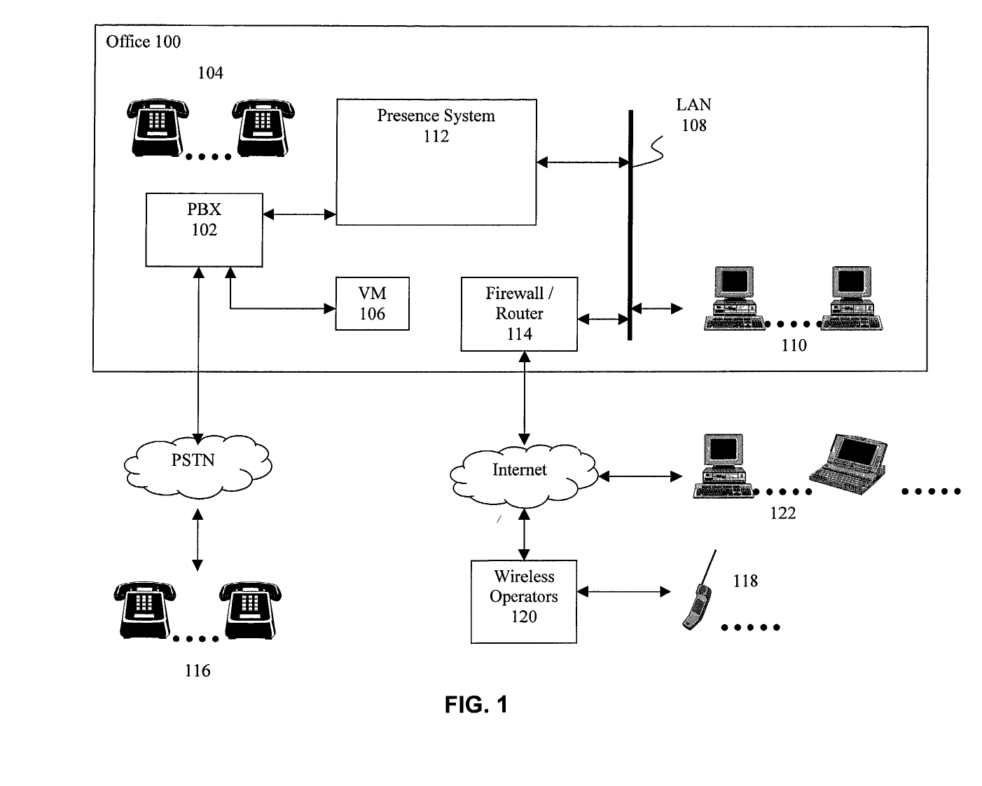

FIG. 1 illustrates an example topology for an implementation of the present invention in accordance with one embodiment.

As can be seen, an office 100 includes a PBX 102 that connects a plurality of office phones 104 and a voice mail service (VM) 106. The office 100 further includes a local area network (LAN) 108 (such as an Ethernet LAN) that connects a plurality of office PCs 110. The PBX 102 can be, for example, a Meridian 1™ PBX switch from Nortel Networks. The voice mail service (VM) 106 can be, for example, a Meridian Mail voice mail system from Nortel Networks. In one example, VM 106 maintains mailboxes for each of the phones 104, which mailboxes may be identified with the same phone numbers associated with phones 104 (e.g. a 4 or 5 digit extension), and includes an Interactive Voice Response system (IVR) for interacting with, and thereby allowing callers to record and play messages in the mailboxes. A presence system 112 in accordance with the present invention is further coupled to the PBX 102 and the LAN 108. The presence system 112 and voice mail service 106 can further communicate with PBX 102 to receive and handle phone calls from within and outside the office 100. Presence system 112 may also communicate with PBX 102 over a separate Ethernet LAN (not shown) using a call control protocol such as the Applications Module Link (AML) protocol from Nortel Networks and equivalent protocols of other equipment suppliers.

The office 100 is coupled to the Public Switched Telephone Network (PSTN) via the PBX 102 and to the Internet via a firewall/router 114 (both connections may be accomplished using a common collection of lines, for example, as should be apparent to those skilled in the art). The office 100 is connected to a plurality of PSTN phones 116 via the PSTN and a plurality of Internet appliances 122 (e.g. a PC, laptop, handheld or other wired device having browser functionality for communicating with remote devices using conventional protocols such as HTTP) via the Internet. The office 100 is also connected via the Internet for providing text messages to a plurality of wireless devices 118 (e.g. one-way and two-way pagers, WAP and/or SMS-enabled cell phones and PDAs, etc.) via their wireless operators 120 (using protocols such as HTTP, SMTP, etc.). Preferably, the firewall/router 114 includes security extensions for providing secure access between the presence system 112 and wireless operators 120 via the Internet.

Generally, the present invention allows a user having an office desk phone and/or office phone/mailbox number to define how incoming calls and messages to the user from within or outside the office should be directed to any communication or message device available to the user, based on presence information associated with the user. The user can specify one or more of the office phones 104, office PCs 110, PSTN phones 116, wireless devices 118, or Internet appliances 122 as available communication or message devices. For example, the user may establish delivery profiles for a number of presence contexts, which presence contexts can include “at desk” (i.e. near the user's office phone and PC), “campus roam” (i.e. in the office but away from the user's office phone and PC) and “out of office” (i.e. away from the office, whether during work hours or after work hours). The user may configure a profile that establishes a set of delivery options for each of these contexts. For example, when the user is on “campus roam,” the user may specify that incoming callers may choose to be routed to the user's cell phone or a temporary phone, or to send a text message to the user's pager.

The present invention further keeps track of the user's presence context. Accordingly, when the user changes from being at his desk to being in the office environment but away from his office desk phone and/or PC (i.e. “campus roam”), the user's stored profile corresponding to the “campus roam” context is automatically consulted for subsequent incoming calls. Such a stored profile can specify that an incoming caller to the user's desk phone is given the option of instead calling the user's cell phone or the user's temporary phone (e.g. the user will be working in a lab away from her desk for an extended period), or the caller can choose to leave a short text message for the user, which will be displayed on a device selected for this context by the user (e.g. the user's pager). When the user is away from the office, a different set of options can be provided to incoming callers in accordance with another profile established by the user.

It should be noted that not all of the “office” components shown in FIG. 1 need be located at the same physical site. For example, the components may be located in different buildings. Other configurations may include shared or “virtual” PBX functionality (e.g. Centrex) that is available to different customers, who may or may not be located in the same office space.

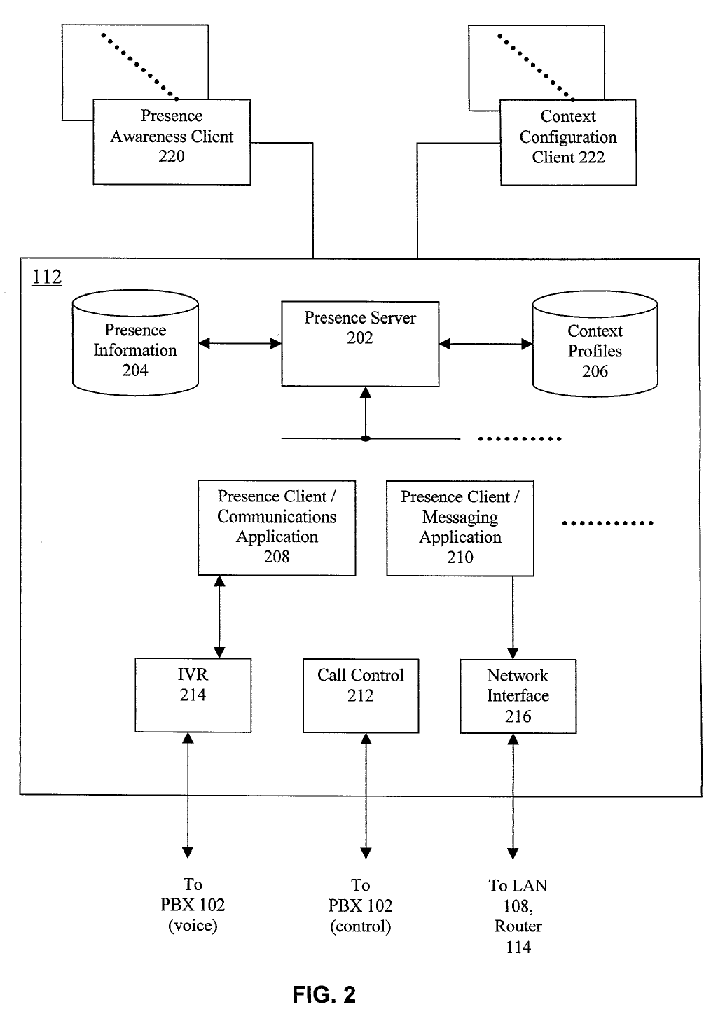

FIG. 2 illustrates an example of a presence system in accordance with an embodiment of the invention in more detail. It should be noted that various alternatives to the system described below may exist, which alternatives may include fewer or additional components.

As shown in FIG. 2, a presence system 112 includes a presence server 202, a presence information store 204, a context profiles store 206, a communication application 208 that receives presence and context profile information from the presence server 202 via a presence client, a messaging application 210 that receives presence and context profile information from the presence server 202 via a presence client, a call control interface 212 (e.g. a Computer Telephony Interface (CTI) application), an Interactive Voice Response (IVR) system 214 (e.g. including hardware and drivers such as that provided by Dialogic and software built on tools provided by Opus Maestro), and a network interface 216 (e.g. an Ethernet interface).

In one example of the invention, the components of the presence system illustrated in FIG. 2 are commonly provided in a Windows NT server (e.g. a Compaq ProLiant series server computer running Windows NT 4.0), with certain of the components provided as add-in cards and certain other of the components provided as software modules, or combinations thereof. It should be noted that, although shown separately for clarity of the invention, the presence information store and the context profiles store can be commonly or separately provided in a relational database such as a Sybase SQL database. It should be further noted that other types of servers and server platforms are possible.

As indicated in FIG. 2, there can be additional applications that include presence clients and the invention is not limited to the example applications provided in FIG. 2. It should be further noted that the system can include administrator interface functionality and administrative information storage for providing underlying configurations such as user information (e.g. user names, associated desk phone numbers and administrative assistant numbers, associated mailbox numbers, desktop PC addresses, etc.) and wireless operator information (e.g. URLs to HTTP servers or e-mail servers associated with the operators, CLID unblocking information, etc.). Still further, the system may include directory services functionality for allowing applications to look up users by name, for example.

As further shown in FIG. 2, the presence server 202 also communicates with a plurality of presence awareness clients 220 for receiving updates of associated user presence information and maintaining the presence information store 204 accordingly. The presence clients 220 can be associated with manual presence update devices (e.g. a special key on a PBX phone for indicating a current presence context, a user selectable option in a user interface that is provided by an IVR, a HTML or WML web page presented on a web-connected wired or wireless device having a browser functionality, or a PC application that communicates with presence server 202 via a LAN or other network connection using a TCP/IP or other protocol, etc.) or they may be associated with automatic presence update devices (e.g. GPS functionality in a cell phone or other wireless device that is carried by the user, an office door sensor that signals a context change when the door is opened or closed, a client application with a travel service that learns when a user has checked into a hotel or is on a flight, a client application that works with a user's stored calendar information to determine when a user is in a meeting, an indication of the on/off status of a user's cellular phone, etc.). Such presence information can include the current presence state or context of the user (e.g. “at desk,” “campus roam,” etc.), or can include information that allows server 202 to infer the user's current presence state or context. Accordingly, the presence server 202 maintains in presence information store 204 a current presence state or context for each user supported by the presence system, which information can be indexed by user mailbox number, for example. It should be noted that a default presence state or context may be established for each user (e.g. the user is “at desk”) in the event a manual or automatic detection of the user's presence state or context has not been made.

The presence server 202 further communicates with a plurality of user presence context configuration clients 222 for receiving associated user context profile configuration information and maintaining the context profiles store 206 accordingly. The context profiles define the communication devices that are available to the user, and how they are to be offered to incoming callers in each of the presence contexts. Accordingly, the presence server 202 maintains in context profile 206 store a set of profiles corresponding to each supported presence state or context (e.g. “at desk,” “campus roam,” etc.), for each user supported by the presence system, which information can be indexed by user mailbox number, for example. It should be noted that there may be default profiles for each user if the user has not interacted with a presence context configuration client for setting his own profiles. Such default profiles can specify, for example, that the user's desk phone should be attempted first in all presence contexts, and then the call should be directed to voice mail if the desk phone is not answered within a predetermined number of rings, as is similar to a conventional messaging system configuration.

The communication application 208 is informed about a user's current presence context from the presence server 202 (e.g. whenever the user's context or profile is changed). Depending on the user's current presence context, the communication application 208 retrieves the appropriate context profile from the presence server 202. The communication application 208 then takes steps to configure PBX 102 in accordance with the user's preferences for how future incoming calls should be treated based on the context profile. For example, if the user's context profile indicates that incoming calls to the user should immediately be transferred to a particular phone (e.g. the user's desk phone or administrative assistant's phone), the communication application 208 configures the PBX 102 via the call control interface 212 accordingly. If the user's context profile indicates that callers are to be given selections on how to contact the user (either immediately or after there has been no answer at a specified phone), then the communication application 208 provides the IVR 214 with the selections and configures the PBX 102 via the call control interface 212 so that the call is transferred to IVR 214 (either immediately when the call comes in to PBX 102 or after there has been no answer at a specified phone for a number of rings).

It should be noted that presence system 112 may not necessarily control processing by PBX 102 of incoming calls for all phones 104 in office 100. Rather, presence system 112 may only control processing of calls to certain users having phone numbers in office 100, while others are handled by PBX 102 in the conventional manner. In other words, all calls to phones connected to PBX 102 in the office 100 are initially received and handled by PBX 102. Presence system 112 dynamically configures PBX 102 for special call and messaging treatment for certain users associated with phones 104, while PBX 102 is statically configured to provide standard phone and messaging treatment to certain other users who are not registered with presence system 112 (e.g. transfer the call to the employee's desk phone, and then to VM service 106 if the employee does not pick up within four rings).

Communication application 208 also controls certain activities when incoming calls for users are received by PBX 102 and forwarded to IVR 214 for presenting options to the caller. Depending on the option selected by the incoming caller via the IVR 214, the communication application 208 can cause the call to be appropriately forwarded by PBX 102 via the call control interface 212 (e.g. call the user's cell phone or transfer the incoming caller to VM 106). Communication application 208 may also reserve control of the forwarded call in the event that the forwarded call cannot be completed by causing call control interface 212 to send the appropriate call control signals to PBX 102 (e.g. signal PBX 102 to switch the call back to IVR 214 if the user's cell phone is not answered within four rings).

If the user's context profile allows the caller to provide a text message, and if the incoming caller selects a text message via a choice presented by IVR 214, the communication application 208 collects the text for the message via the IVR 214 and alerts the messaging application 210, which then takes steps to forward the text message to the user. The messaging application 210 retrieves the user's current presence context from the presence server 202, and then retrieves the user's text message configuration for the current context from the presence server 202. The text message configuration may be, for example, to send a text message to the user's desktop PC first, then if not responded to within two minutes, send the text message to the user's pager. The messaging application 210 then interacts with the network interface 216 to cause the message to be sent to the user's preferred wired device within the office's LAN 108 or via the Internet, or to the user's preferred wireless device via an Internet gateway for the wireless operator 120 associated with the specified wireless device 118.

The messaging application 210 can use a protocol such as TCP to send text messages to desktop PCs 110 in the office's LAN 108 or other wired device via the Internet. Such desktop PCs or wired devices are configured with message receiving functionality in order to display the received messages. In one example of the invention, this functionality is provided by installing a messaging application that continually runs on the desktop PC or wired device and is configured to listen for messages sent by the messaging application on the office's LAN 108 or network and which are addressed to the user associated with the desktop PC. However, it should be apparent that the invention is not limited to this example, and that other types of instant messaging applications may be used (e.g. ICQ, AIM, etc.).

For certain wireless devices 118 such as pagers, the messaging application 210 is configured to send the text message to the wireless operator 120 associated with the device via the network interface 216 and the Internet. The wireless operator 120 then uses whatever format it needs (e.g. SMS, WAP or pager formats) to forward the text message to the device. In one example of the invention, the messaging application 210 is configured to send text messages to wireless devices via their operators either using the HTTP protocol or the SMTP protocol. In order to access these devices for messaging, presence system 112 needs to be configured to recognize and communicate with the associated operator 120 for transferring text messages. For example, the system may be configured with the Internet address of the operator and the form of a URL through which text messages can be posted via an HTTP protocol for re-transmission by the operator to the user's wireless device (e.g. www.verizon.com/cgi/sendsms?num=ccc-nnn-nnnn&msg-“Hello There”, which causes a wireless subscriber of Verizon Wireless having a phone/pager number of ccc-nnn-nnnn to receive a SMS text message of “Hello There”). Users can be permitted to receive messages only with devices that are associated with these pre-configured operators. For wireless devices that use a SMS or paging service such as cell phones and pagers, for example, the operator is configured to relay the message to the device using the SMS and/or particular pager protocol.

In addition to receiving text messages from an incoming caller via the IVR, the messaging application 210 may further include functionality for receiving text messages from office PCs via the office's LAN 108 or other connected devices via the network interface 216 and forwarding them to specified users. For example, the messaging application 210 may include server functionality for interacting with messaging clients in PCs 110 (e.g. using TCP protocol and/or instant messaging applications), WAP-enabled wireless devices 118 (e.g. using WTP protocol and/or instant messaging applications) and Internet PCs or devices 122 (e.g. using HTTP protocol and/or instant messaging applications). Such client functionality can include the ability to enter a short (e.g. 160 characters) message for delivery to a specified user (e.g. by entering the user's phone number). The server functionality in messaging application 210 can receive these messages and retrieve the specified user's presence context from presence server 202. Messaging application 210 can then retrieve the user's context profile corresponding to the user's current presence context to determine how the user is configured to receive text messages in the current context. Depending on the configuration, messaging application 210 can then act to cause the received message to be delivered to the user's selected text messaging device (e.g. desktop PC, pager, etc.) via the network interface 216.

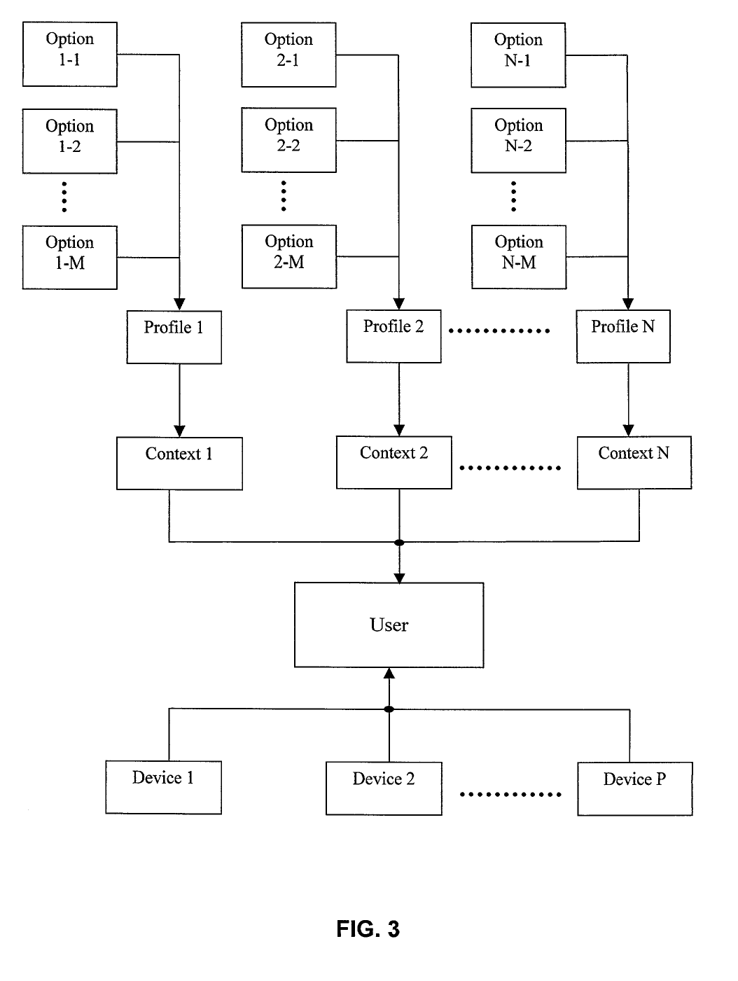

FIG. 3 illustrates an example of the data structure of a presence context profile maintained in context profile store 206 for each user in accordance with one embodiment of the present invention.

As shown in FIG. 3, each user may configure profiles for each context (1 to N) supported by the system. A “context” is a presence state such as “at desk,” “campus roam,” and “out of the office.” Although the present invention will be described in detail with reference to these example contexts, it should be apparent that many other types of contexts may be provided such as “business travel,” “off duty,” “on the phone,” “different campus,” etc. It should be further apparent that not all users need to define profiles for all contexts, that the number of profiles for each user need not be the same, and that default profiles for certain or all of the contexts may be provided.

Each profile contains various options (1 to M) about how to communicate with the user in that associated context. The options can be hierarchical and/or selective (which can be indicated by flags, for example). For example, a profile may be hierarchical in that it can include a first option of always routing an incoming call first to a user's desk phone 104, and the remaining options may become available for selection by a caller only if there is no answer at the desk phone 104 after a certain number of rings. It should be noted that the number of options M for each profile need not be the same, and may depend on the number and type of devices that the user has configured for access.

As further shown in FIG. 3, a user may further configure a number of devices (1 to P) through which the user can be accessed. The type of access can include voice or messaging and other types of media, such as video conferencing. The types of devices can include those located within and outside the office, and wired or wireless. Generally, this includes all types of devices that are accessible by the presence system 112, either through the PBX 102 and PSTN or through the Internet or other network. It should be noted that certain types of devices may be configured automatically for each user by the system itself or a system administrator without requiring user action, such as the user's desk phone 104 and an administrative assistant's phone 104. It should be further noted that the user may configure many of a certain type of device (e.g. cell phone, desk phone, etc.), although the present invention will be described in detail below with only one of a certain type of device configured.

Example methods for allowing a user to customize how their incoming calls should be handled in the various presence contexts, which methods can be used to implement the presence awareness clients 220 and the context configuration clients 222 of the present invention, will now be described with reference to interface screens presented to a user by the presence server 202 and clients 220, 222 in accordance with one embodiment of the present invention.

In the example of the invention that will be described in more detail below, the clients 220, 222 are implemented on PCs 110 or Internet appliances 122 using HTML pages that are presented to a user on a desktop PC using a browser functionality that communicates with the presence server via a LAN or via the Internet, for example. The HTML pages are presented by the server and clients in response to URLs pointing to such HTML pages, as well as scripts (e.g. CGI scripts or servlets and/or Java Server Pages) resident on the server 202, which pages and scripts are specified by the user over a network using the HTTP protocol, for example. Alternatively, clients 220, 222 may be implemented as installed client applications on a desktop PC such as PCs 110 so as to present dialog boxes (such as in Windows or similar operating system applications) for collecting information which is then transmitted to the presence server using a known network address and a communications protocol such as TCP. It should be apparent that many other alternatives are possible.

Further, although the operation of these clients will be described with reference to an example of the invention where the clients 220, 222 are implemented using software running on a desktop PC wired to a network, it should be apparent that other embodiments are possible. For example, the clients may be implemented so as to present WML pages on WAP enabled devices such as WAP enabled cell phones and PDAs such as Palm Pilots. Alternatively, the clients may be implemented using menus presented by an IVR system over a telephone connection. The implementation details of such alternatives will become apparent to those skilled in the art after being taught by the following example of the invention.

It should be noted that additional screens other than those that will be described below may be included for requiring a user to login to the presence server 202 using a mailbox number and password, for example, before allowing the user to invoke the client applications.

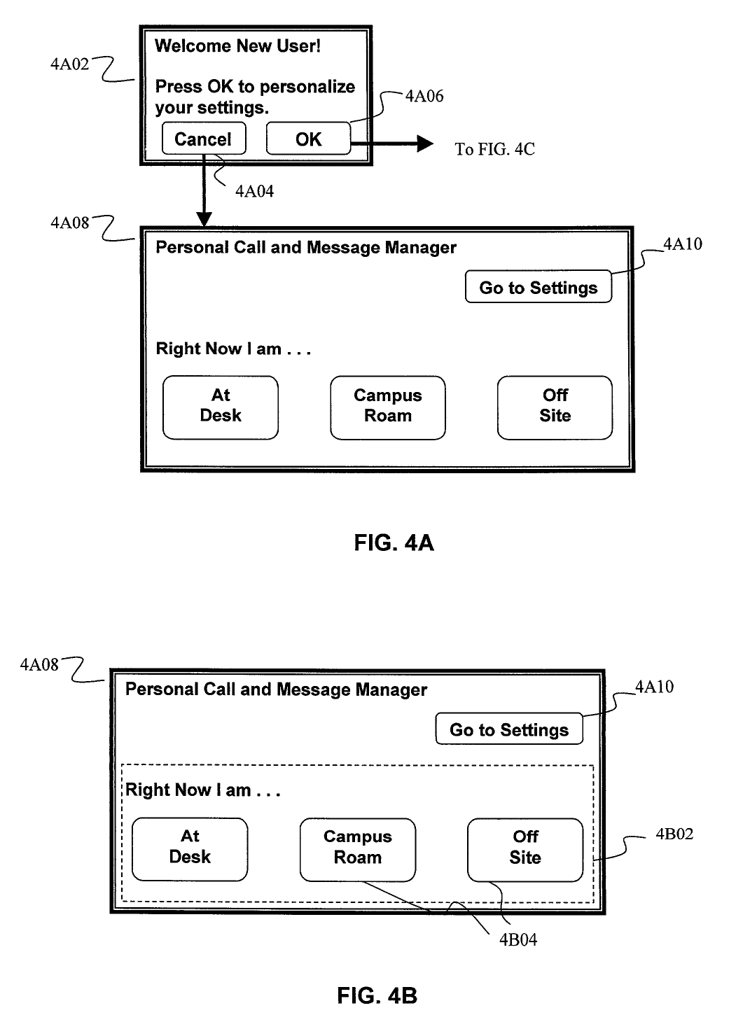

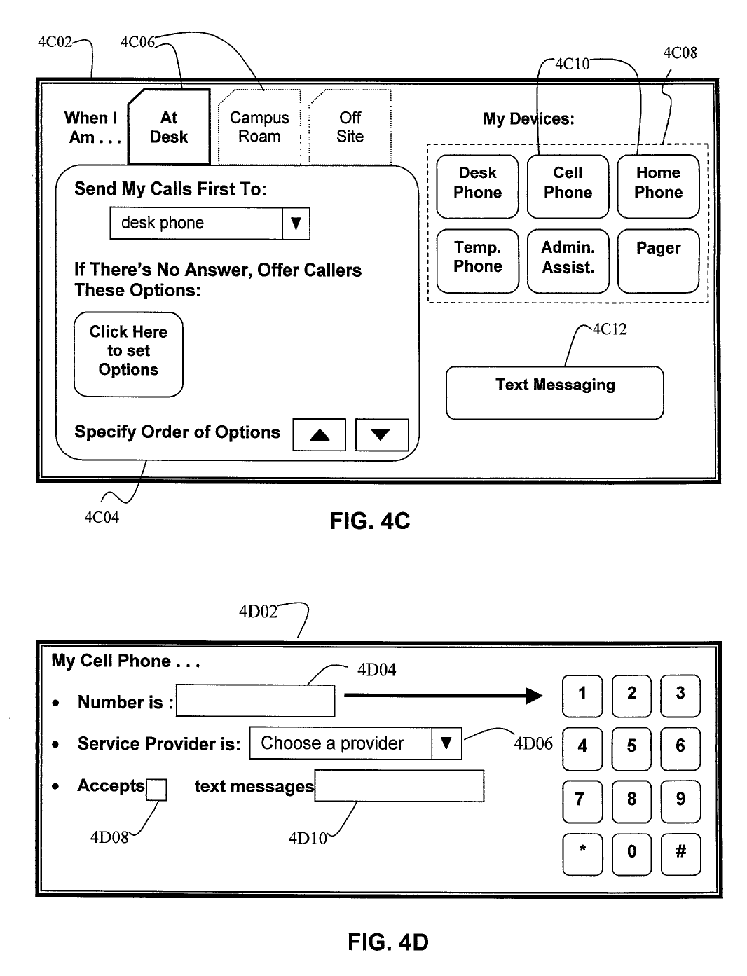

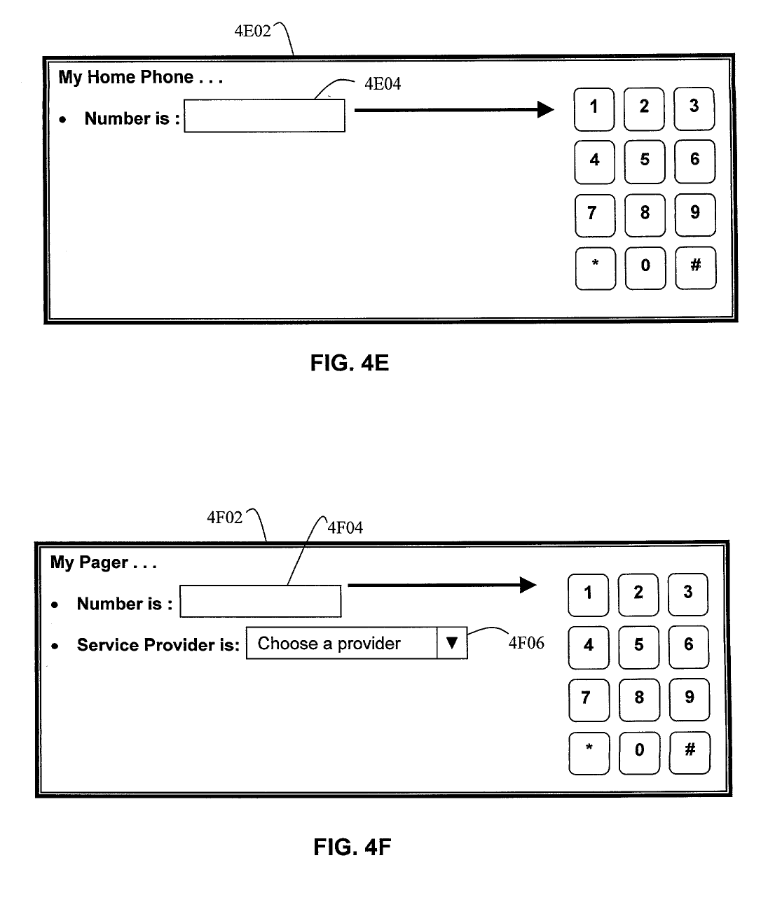

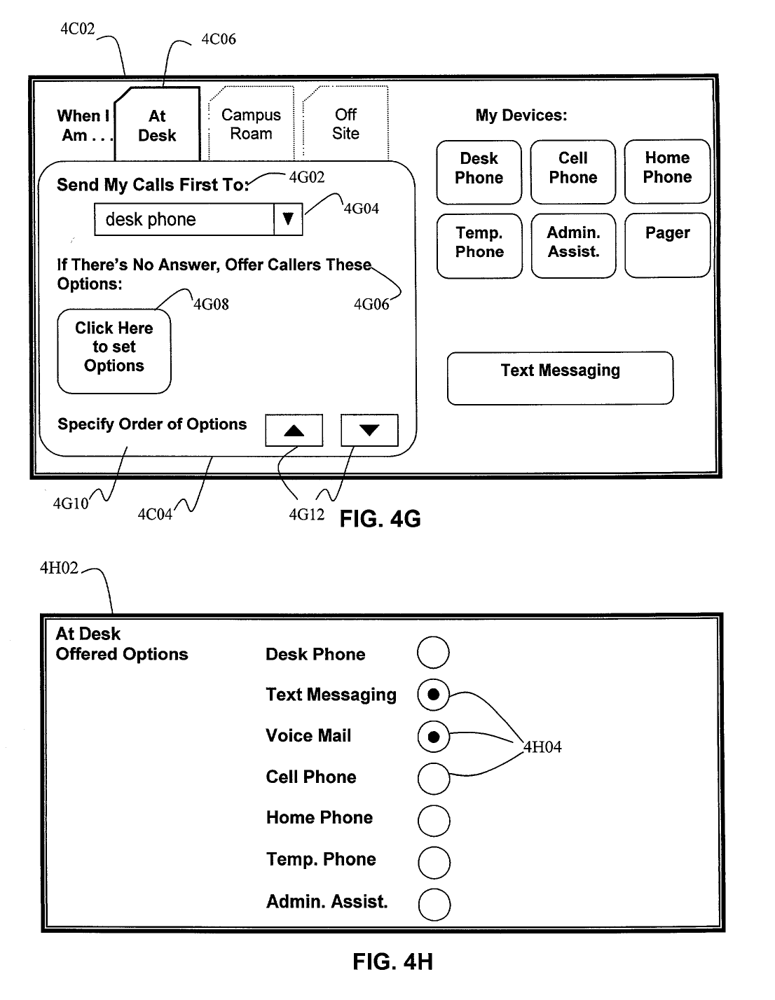

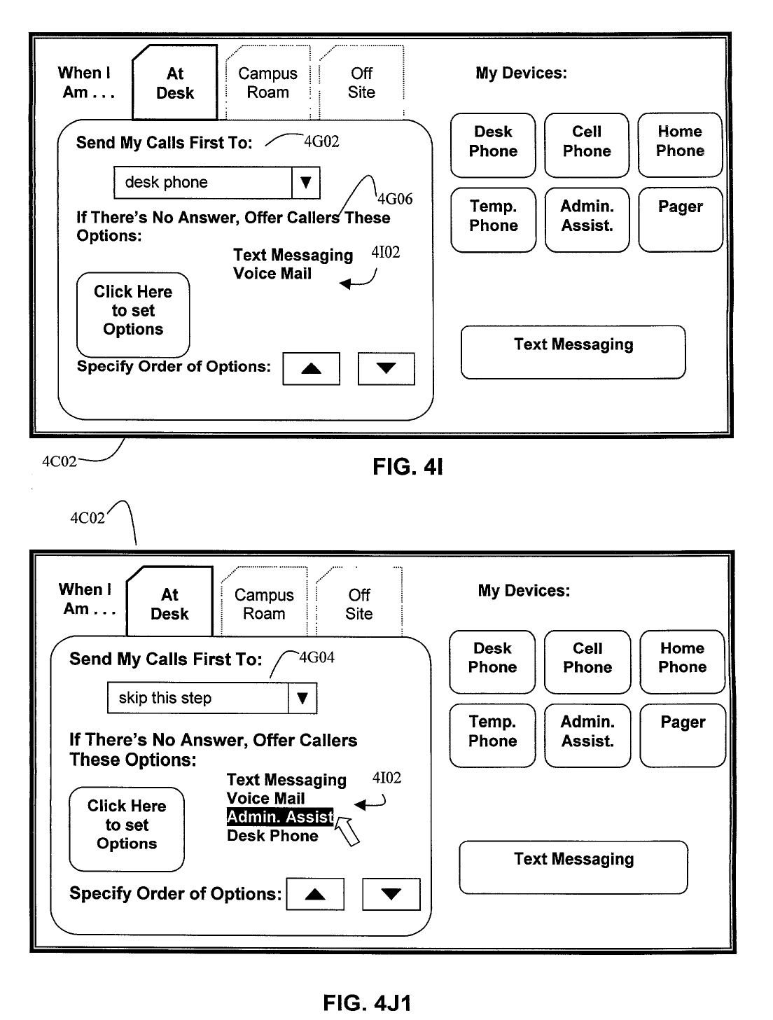

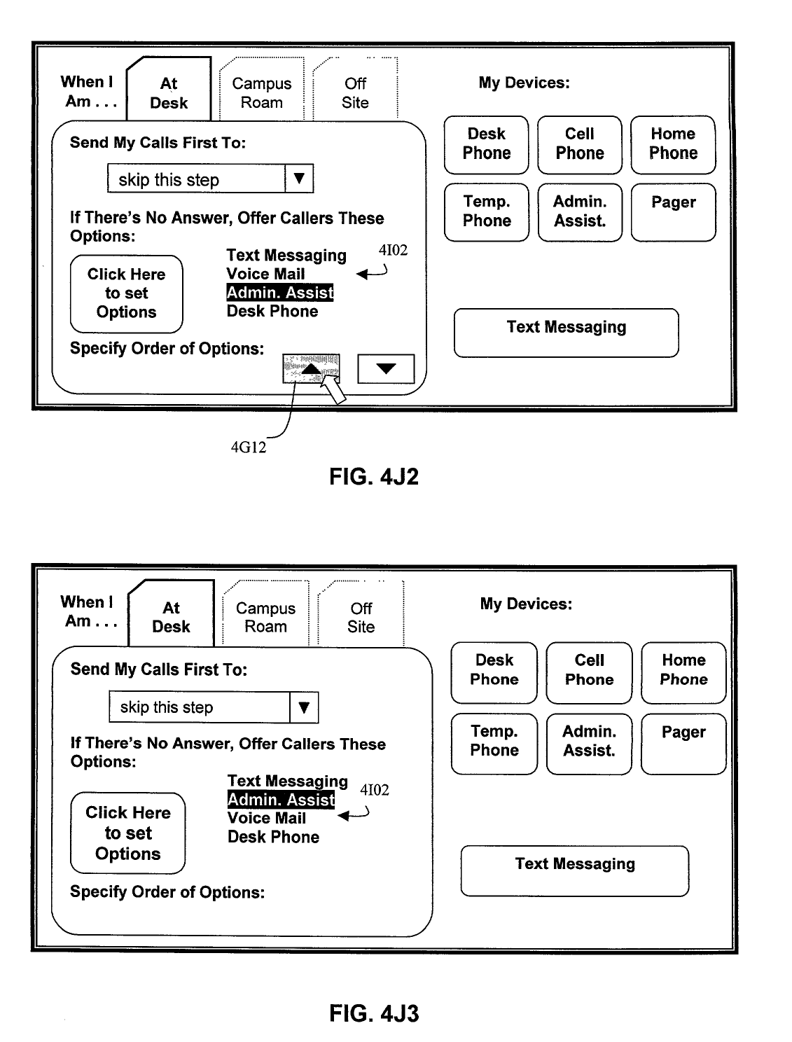

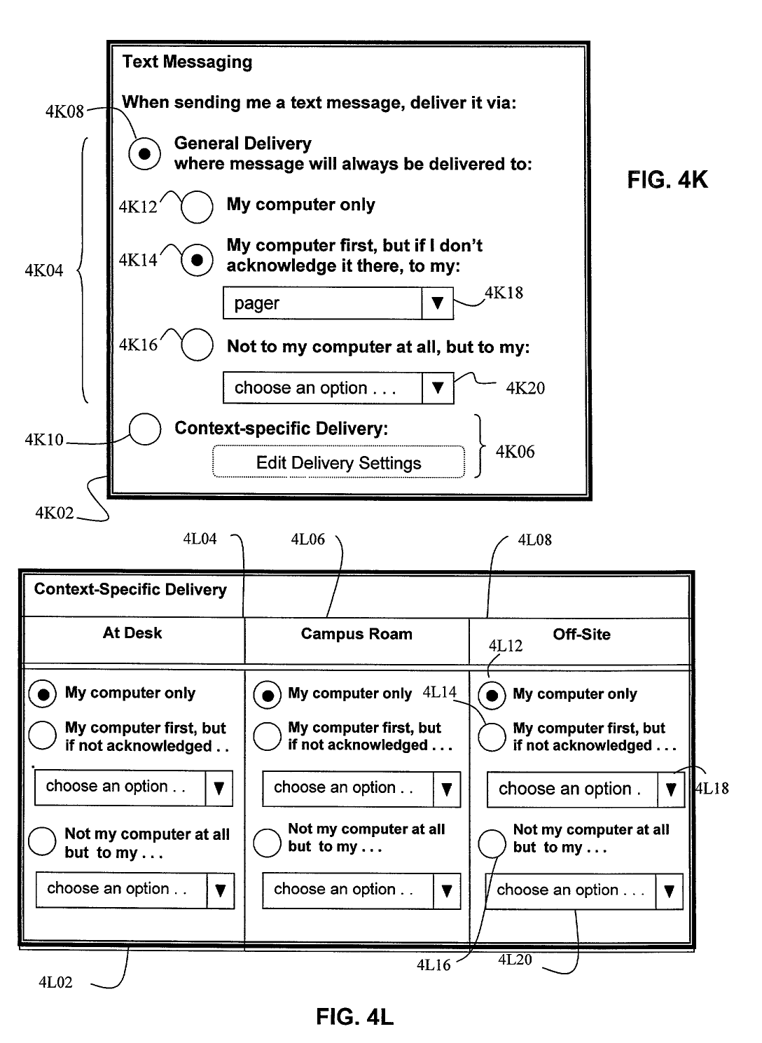

FIG. 4A illustrates examples of how a context configuration client 222 and/or presence awareness client 220 can be invoked on a user's desktop PC in accordance with one embodiment of the present invention.

As shown in FIG. 4A, screen 4A02 illustrates a dialog box that can be presented when a new user first logs on to the presence server, via a desktop PC connected to the server 202 via a LAN connection or an Internet connection, for example. The presence server 202 can detect whether the user has set up any context profiles before, and if so present this dialog to specifically query the user to set up their own customized context profiles. Button 4A04 allows the user to bypass the setup process, which causes screen 4A08 to be displayed, and the presence awareness client 220 to be invoked. Alternatively, if the user already has set up context profiles, screen 4A08 may be immediately displayed once the user has logged on to the presence server 202.

If the new user wishes to set up the user's context profiles, screen 4A02 includes an “OK” button 4A06 for invoking the context configuration client 222. Alternatively, as further shown in FIG. 4A, screen 4A08 includes “settings” button 4A10 for allowing the user to change or add context configuration settings after an initial configuration may have been performed.

FIG. 4B is a dialog box presented by an example of a presence awareness client 222 on a desktop PC according to one embodiment of the invention.

As shown in FIG. 4B, screen 4A08 includes a region 4B02 for allowing the user to click on one of three buttons 4B04 associated with respective presence contexts: “at desk,” “campus roam,” and “off site.” When the user clicks on any of these buttons, the presence awareness client 220 sends a message to the presence server 202 advising the server that the user's presence context has changed to that corresponding to the clicked button. In response to this message, the presence server 202 updates the user's presence context accordingly.

As discussed more fully above, there may be many alternatives for allowing a user to change a current presence context. For example, the user's desk phone may have preconfigured buttons or selections allowing a user to specify a change in context. The selection of such buttons will be received by a presence awareness client 220 in the PBX 102 which then sends a message to the presence server 202. Further, the user may be allowed to schedule the change of presence context, possibly in conjunction with a calendar application. Many other alternatives will become apparent to those skilled in the art after being taught by these examples.

FIG. 4C is a first dialog box that illustrates processing by a context configuration client 222 for the “at desk” context. This dialog box can be presented either when the user selects the “OK” button 4A06 in screen 4A02 or the “settings” button 4A10 in screen 4A08, for example.

As shown in FIG. 4C, screen 4C02 includes an area 4C04 from which a user can configure profile information for a specified presence context. The presence context for configuration can be selected using tabs 4C06.

Screen 4C02 further includes an area 4C08 that can be used to configure devices that can be used to contact the user in one or more of the presence contexts. Buttons 4C10 in area 4C08 are provided for allowing a user to launch a dialog for configuring respective types of devices. It should be noted, however, that certain devices may be automatically configured by the system and/or an administrator without user action. For example, a user's desk phone and administrative assistant's phone can be configured by the system with information received from the PBX 102. The user may or may not be allowed to override these settings.

Screen 4C02 further provides a button 4C12 that allows a user to launch a dialog for configuring how the user prefers to receive text messages.

FIG. 4D is a dialog box that illustrates processing by the context configuration client 222 for defining a cell phone device. This dialog box can be presented in response to a user clicking on an associated button 4C10 in area 4C08, for example.

As shown in FIG. 4D, screen 4D02 includes a field 4D04 for allowing a user to specify the phone number associated with a cell phone (which can be entered using keys on the user's own device keypad, or by pointing and clicking numbers in the keypad shown in screen 4D02, for example), a field 4D06 with a drop-down list for allowing a user to specify a service provider associated with the cell phone, and a checkbox 4D08 for allowing a user to specify whether the cell phone is capable of receiving text (e.g. SMS) messages, and if so, a field 4D10 allows a user to specify an address (e.g. a 10-digit phone number or other number issued by the associated service provider for such messages) that allows the service provider to forward the text message appropriately. The drop-down list in field 4D06 is provided because generally, the system has a pre-configured list of service providers that the system is capable of communicating with. However, the invention is not limited to this illustrative example.

FIG. 4E is a dialog box that illustrates processing by the context configuration client 222 for defining a home telephone device. This dialog box can be presented in response to a user clicking on an associated button in screen 4C10 in area 4C08, for example. It should be apparent that similar processing could be performed for defining other standard telephones, such as a temporary telephone or an administrative assistant's telephone. It should be further apparent that such phones can include both phones 104 within the office environment PBX 102 and phones 116 outside the office environment PBX 102 and accessed through the PSTN. Accordingly, such phones can also include cell phones, as long as the user does not want to take advantage of the special text message display features that are accessible with the invention and are configured as described in FIG. 4D.

As shown in FIG. 4E, screen 4E02 includes a field 4E04 that allows a user to specify a home phone number. The phone number can include an area code and/or country code if the home telephone is outside the area code of the user's office.

In general, when configuring numbers of telephones, the number entered may be a four or five digit extension if the phone is within the PBX 102. That is, phone numbers entered by a user for available phones are preferably entered as they would be dialed by the user from the user's desk phone. Alternatively, the context configuration client 222 may include functionality for determining the numbers and prefixes to be associated with telephone numbers that the user enters (e.g. by looking up entered numbers in a directory) so that they can be properly dialed by PBX 102.

FIG. 4F is a dialog box that illustrates processing by the context configuration client 222 for defining a pager device. This dialog box can be presented in response to a user clicking on an associated button in screen 4C10 in area 4C08, for example.

As shown in FIG. 4F, screen 4F02 includes a field 4F04 for allowing a user to specify a phone number associated with the pager, and a field 4F06 with a drop-down list that allows a user to specify the service provider associated with the pager. As with the cell phone, the drop-down list is provided because generally, the system has a pre-configured list of service providers that the system is capable of communicating with.

FIG. 4G is a dialog box that illustrates processing by the context configuration client 222 for defining user preferences for a specific context, such as an “at desk” context. In one example of the invention, the options available for configuring each context are the same. However, it should be apparent that this is not necessary.

As shown in FIG. 4G, and as set forth above, when a user viewing screen 4C02 selects a tab 4C06, an area 4C04 is displayed that includes fields that allow the user to specify configuration settings for the context associated with the selected tab. A first sub-area 4G02 allows a user to specify how incoming calls to the user's desk phone are first treated. It includes a field 4G04 with a drop-down list that includes, preferably, phones 104 in the office where the user generally prefers to be reached (e.g. the user's desk phone or the user's administrative assistant's phone). The drop-down list may further include a selection that allows this step to be skipped and for incoming calls to be routed directly to the IVR 214 of the presence system 112.

A second sub-area 4G06 allows a user to specify what other devices the incoming caller may select for reaching the user in this context. For example, if the user specifies from sub-area 4G02 that calls should be first routed to the user's desk phone, and if the user does not answer the desk phone, then the system will use the devices specified by the user from sub-area 4G06 to provide a list of other options on how to contact the user. Alternatively, if the user specifies from sub-area 4G02 that no phone should be attempted first, then the system will use the devices specified by the user from sub-area 4G06 to immediately provide the caller with a list of options on how to contact the user. In the example screen 4C02, to specify the device options to present to incoming callers, the user must click on button 4G08 in sub-area 4G06 which will launch another dialog that allows the user to specify those options.

A third sub-area 4G10 includes up and down buttons 4G12 that allow a user to specify the order in which the devices selected from sub-area 4G06 are offered as selections to the incoming caller, as will be explained in more detail below.

FIG. 4H is a dialog box that illustrates processing by the context configuration client 222 for defining user preferences for what devices should be used to attempt to contact the user while the user is in a presence context selected by a tab 4C06 from screen 4C02, such as an “at desk” presence context. This dialog can be launched when a user clicks on button 4G08 in screen 4C02, for example.

As shown in FIG. 4H, screen 4H02 includes a column of radio buttons 4H04 associated with all devices that the user has currently configured for receiving incoming calls or messages. It should be noted that, if the user has selected to first receive calls at, for example, the user's desk phone, then this device may not have a corresponding radio button 4H04 provided in screen 4H02. The user selects which devices will be available for selection by the incoming caller in the corresponding presence context by clicking on the associated radio button 4H04 in screen 4H02.

FIG. 4I illustrates an example of how screen 4C02 will appear after the user has selected the devices in screen 4H02. As shown in FIG. 4I, sub-area 4G06 now includes the list 4I02 of devices that have been selected for presentation to incoming callers. In this example screen associated with configuring the “at desk” presence context, the user has selected in sub-area 4G02 that calls should first be routed to the user's desk phone. Thereafter, as provided in sub-area 4G06, the user has configured his profile for this presence context such that, if the desk phone is not answered after a predetermined number of rings, the incoming caller will be allowed to attempt to send a text message or leave a voice mail for the user.

FIGS. 4J1 to 4J3 illustrate processing by the context configuration client 222 for allowing a user to change the order in which call and messaging options are presented to incoming callers while the user is in a presence context associated with tab 4C06 in screen 4C02, for example an “at desk” presence context. In the example screen 4C02 shown in FIG. 4J1, the user has configured the profile corresponding to the “at desk” context such that calls to the user's desk phone are immediately forwarded to the presence system 112 for handling (see the field 4G04 in FIG. 4J1, which contains the setting “skip this step”). As further shown in list 4I02 in FIG. 4J1, the user has also configured the profile corresponding to the “at desk” presence context such that incoming callers will be allowed to attempt to reach the user by text message, voice mail, administrative assistant's phone and desk phone.

The devices shown in list 4I02 will be offered for selection to incoming callers in the order they are presented in that list. To change the order in which a device is offered for selection, the user highlights the device to be changed (e.g. “administrative assistant” in FIG. 4J1), and then clicks one of the up and down buttons 4G10 (e.g. the up button as shown in FIG. 4J2). The result is shown in FIG. 4J3 where the selected device has replaced “Voice Mail” as the next highest option in the list 4I02.

FIG. 4K is a dialog box that illustrates processing by the context configuration client 222 for allowing a user to define how text messages may be received by the user. This process can alternatively be described as defining a text messaging device. This dialog box may be presented in response to a user selecting button 4C12 in screen 4C02, for example.

As shown in FIG. 4K, screen 4K02 includes two options for delivery of text messages. First sub-area 4K04 allows a user to specify general delivery (i.e. non-context specific) of text messages, while sub-area 4K06 allows a user to specify context-specific delivery of text messages. General delivery is selected by button 4K08 and context-specific delivery is selected by button 4K10. The two buttons cannot be selected simultaneously, and in this example general delivery has been selected. The selection has enabled the setting of options in sub-area 4K04, and has disabled the setting of options in sub-area 4K06.

As further shown in FIG. 4K, when general delivery is selected, the user has a further option of selecting one of buttons 4K12, 4K14 and 4K16. If button 4K12 is selected, text messages are only delivered to the user's computer (e.g. the computer 110 connected to the user's office LAN 108). If button 4K14 is selected, text messages are first delivered to the user's computer, then to another device (e.g. pager, cell phone, etc.) if the message is not acknowledged within a predefined period of time (e.g. two minutes). The other device is selected from drop-down list 4K18. If button 4K16 is selected, text messages are delivered only to a device selected from drop-down list 4K20.

When context-specific delivery is selected, another dialog box is displayed, as set forth in connection with FIG. 4L.

FIG. 4L is a dialog box that illustrates processing by the context configuration client 222 for allowing a user to define how text messages are received by the user while the user is in different presence contexts. This dialog box can be presented when the user selects button 4K10 in screen 4K02, for example

As shown in FIG. 4L, screen 4L02 includes areas 4L04, 4L06 and 4L08 for setting the text delivery options in each of the “at desk,” “campus roam,” and “out of office” contexts, respectively.

As in the general delivery option in FIG. 4K, for each of the contexts, the user has a further option of selecting buttons 4L12, 4L14 and 4L16. If button 4L12 is selected, text messages are only delivered to the user's computer. If button 4L14 is selected, text messages are first delivered to the user's computer, then to another device if the message is not acknowledged within a predefined period of time (e.g. two minutes). The other device is selected from drop-down list 4L18. If button 4L16 is selected, text messages are delivered only to a device selected from drop-down list 4L20. Although in this example of the invention, the options available in each context are the same, it should be apparent that the invention is not limited to this example, and that there can be different sets of options for each context.

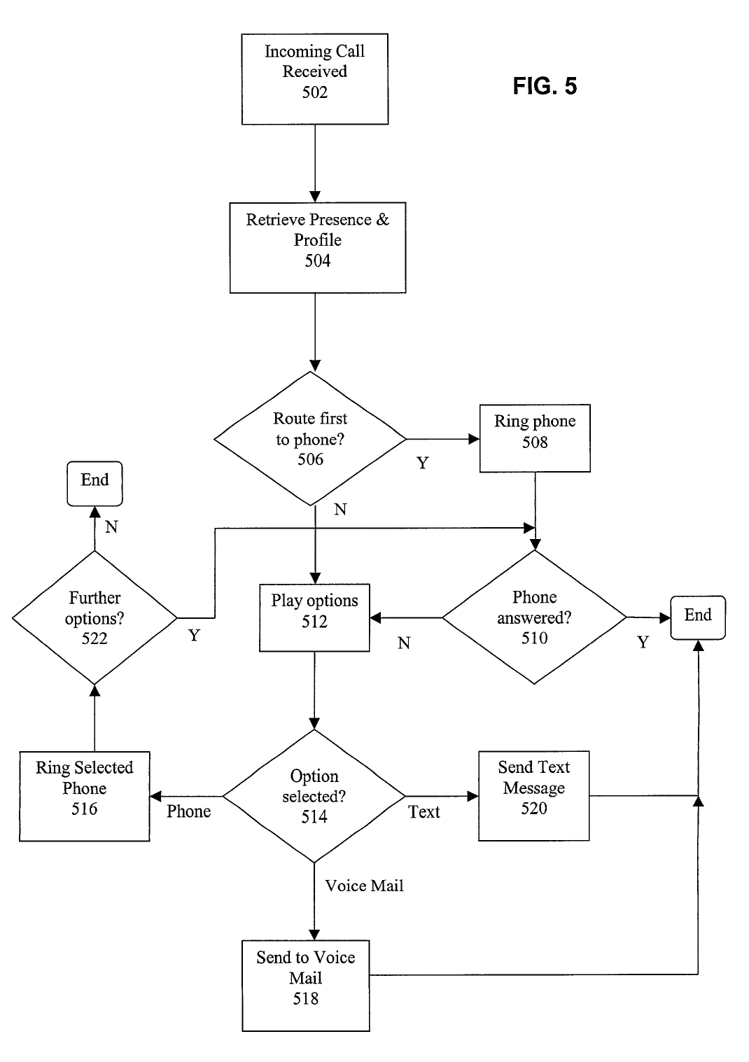

FIG. 5 is a flowchart illustrating an example method of handling an incoming call to a user based on the user's presence information as performed by a presence system 112 in accordance with one embodiment of the present invention.

As shown in FIG. 5, in block 502 the presence system is notified that an incoming call to a user of the presence system 112 has been received. In block 504, the user's current presence state is determined, and the user's context profile corresponding to the user's current presence state is retrieved. If the user's context profile indicates that the incoming call in the current presence context is first directed to a phone (e.g. the user's desk phone or the user's administrative assistant's phone, as determined in block 506), the call is directed to that phone (block 508). If the phone is answered (determined in block 510), no further processing is performed. If the phone is not answered, or if the user has configured the context such that no phone is immediately attempted for an incoming call, processing advances to block 512, where the list of options for the incoming call is played to the incoming caller via an IVR. These options can include, for example, calling the user on a temporary or home phone, sending a text message to the user, or leaving the user a voice mail. Accordingly, the system collects the incoming caller's selection (block 514) and directs the call in a manner corresponding to the selection (blocks 516, 518 and 520).

For the case where the incoming caller selects ringing another phone (e.g. the user's home phone or temporary phone), the system may further determine whether the user has configured any further options in the event that that phone is not answered (e.g. within a predetermined number of rings). If so (determined in block 522), processing returns to block 510, otherwise processing ends. It should be noted that the other selected phone may have a voice mail system or cell phone operator that may pick up the phone itself after a predetermined number of rings. In that event, the phone is considered answered in block 510, and the presence system performs no further processing. It should be further noted that no additional processing may be performed if the first phone is not answered.

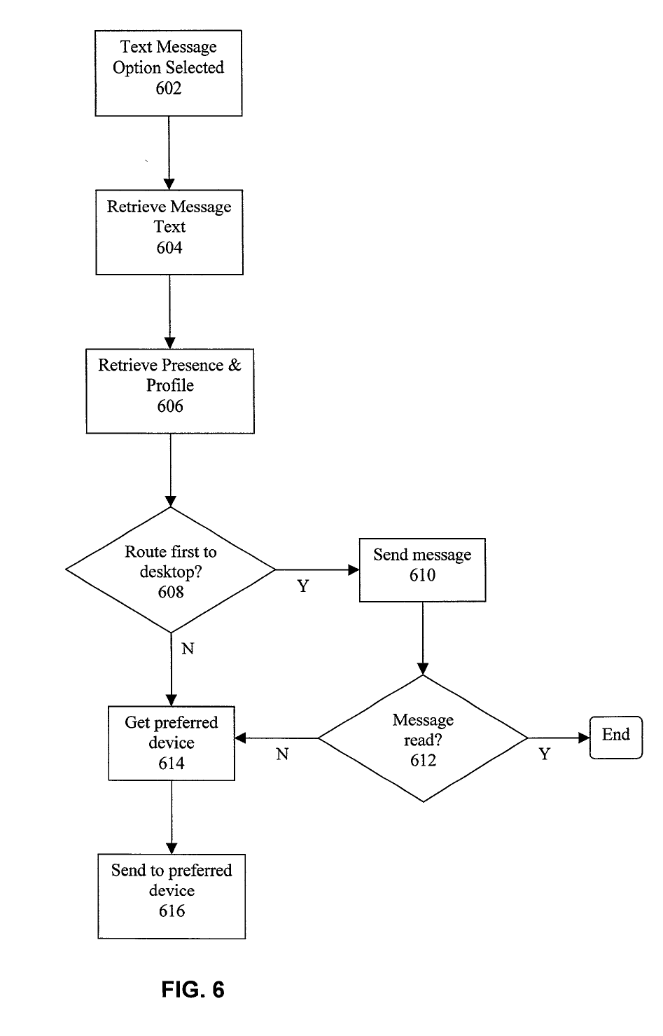

FIG. 6 is a flowchart illustrating an example method of forwarding a text message to a user based on the user's presence information and text messaging preferences as performed by a presence system 112 in accordance with one embodiment of the present invention.

As shown in FIG. 6, in block 602 the presence system is notified that an incoming caller wishes to leave a text message for the user. This can be done in response to a list of options presented to the incoming caller such as in block 512 in FIG. 5. Accordingly, in block 604, the text for the message to be sent to the user is collected. In one example of the invention, this is done by causing the IVR 214 to allow the incoming caller to select from one of a number of predetermined or “canned” messages such as “call me,” “meeting started,” “meeting delayed,” etc. The IVR may be further configured to allow certain or all of these messages to be appended with numeric information (since callers almost universally will be able to enter numbers via a phone keypad). For example, the “call me” message can be appended with the caller's phone number. The IVR 214 provides the messaging application 210 with the caller's message selection and any appended message information. Alternatively, text messages may be collected by messaging application 210 from other office PCs 110 and other networked devices via network interface 216.

In block 606, the user's current presence state is determined, and the user's context profile corresponding to the user's current presence state is retrieved. If the user's context profile indicates that the text message in the user's current presence context is first directed to the user's desktop PC, the text message is sent to that PC (block 610). If the message is acknowledged (determined in block 612), or if the user has not configured any other text messaging options for this presence context, then no further processing is performed. If the message is not acknowledged, or if the user has configured the context such that the user's desktop PC is not immediately attempted for a text message, then processing advances to block 614, where the user's preferred non-desktop PC device for receiving text messages in this context is determined (if any). This device can include, for example, a pager, or a SMS-capable cell phone or PDA. Accordingly, the system prepares the text message for the appropriate device and sends it (block 616).

An aspect of the invention is that it allows a user to be present (or not) across multiple devices, and not only that, across multiple types of devices. Accordingly, it is important for users to be able to state whether a given device is currently available or not. Some of these devices, such as a pager, do not have a discernible network presence, so this must be done manually. Other devices, such as a cell phone, can have their availability tied to its on/off status if that is what a user desires. Others, such as a temporary phone, have an availability that can depend on whether a number is currently associated with them or not. Finally, the use of the term “device” can be extended to refer to a communication means that is associated with a particular person, such as an administrative assistant. If an administrative assistant is currently on holiday or has called in sick, and there is no replacement, then the phone that he or she normally answers can be thought of as being temporarily unavailable.

Thus, when a device is determined to be temporarily unavailable (either through automatic detection or manual setting), despite the fact that a user has defined it as being a valid communication means, it should not be offered to callers/senders until it is available again. Note also that the unavailability of a given device may affect more than one communications means. For example, if a cell phone is unavailable, then that cell phone cannot be used to receive voice calls or text messages (e.g. via SMS).

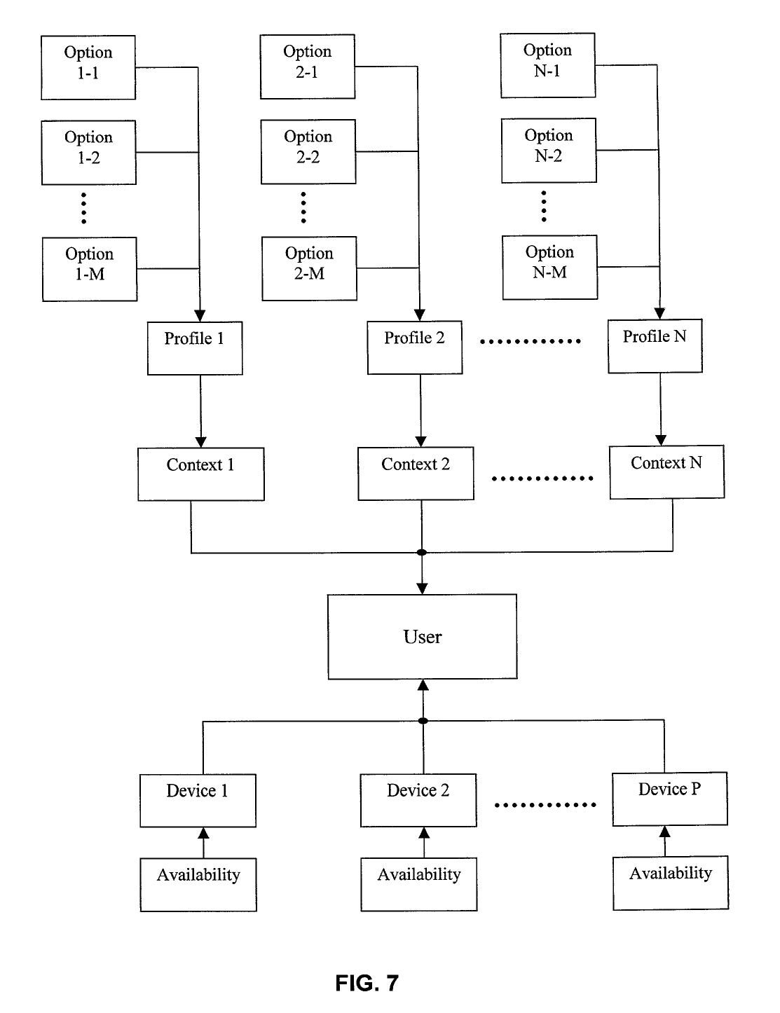

FIG. 7 illustrates another example of the presence context configuration information maintained in accordance with another embodiment of the present invention.

As shown in FIG. 7, the system 112 is further configured to maintain availability information for each device that the user has configured for receiving voice and/or text messages.

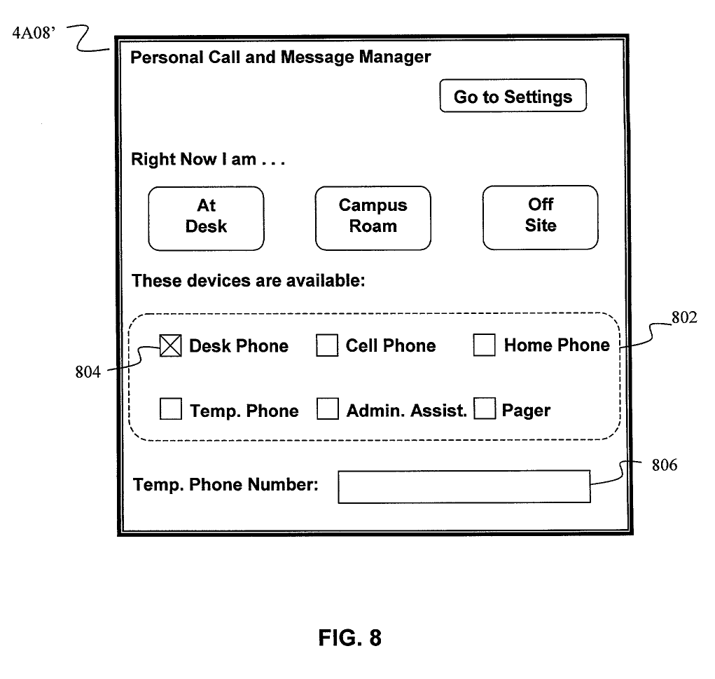

FIG. 8 is a dialog box that illustrates processing by the context configuration client 222 for allowing a user to change the availability settings of devices in a manner similar to that discussed with respect to FIGS. 4A to 4L. In one example of the invention, the availability settings selected by the user will be applied in all presence contexts. However, it should be noted that the invention is not limited to this example.

As shown in FIG. 8, screen 4A08′ further includes an area 802 that allows a user to specify the availability of configured devices. Each device has an associated checkbox 804 that indicates the availability of the device. It should be noted that if a device has not been configured for access in any context, it may be grayed out, and the user may not be able to control the associated checkbox. Moreover, screen 4A08′ further includes a text box 806 for allowing a user to more readily insert or change a temporary phone number without opening up a settings dialog.

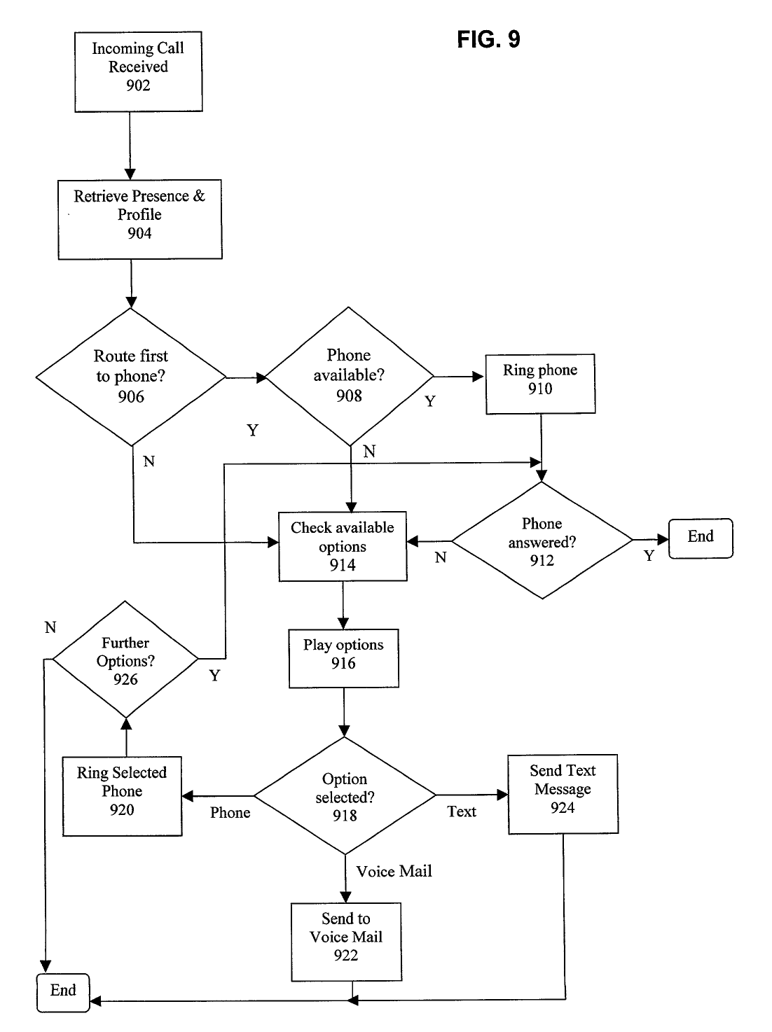

FIG. 9 is a flowchart illustrating an example method of handling an incoming call to a user based on the user's presence information and device availability information as performed by a presence system in accordance with another embodiment of the present invention.

As shown in FIG. 9, in block 902 the presence system is notified that an incoming call to a user of the presence system has been received. In block 904, the user's current presence state is determined, and the user's context profile corresponding to the user's current presence state is retrieved. If the user's context profile indicates that the incoming call in the current presence context is first directed to a phone (e.g. the user's desk phone or the user's administrative assistant's phone, as determined in block 906), it is next determined whether the phone is available (block 908). If so, the call is directed to that phone (block 910). If the phone is answered (determined in block 912), no further processing is performed. If the phone is not answered, or if the user has configured the context such that no phone is immediately attempted for an incoming call, or if the user configured a phone to be immediately attempted but it is not available, processing advances to block 914, where the list of remaining options for the incoming call is examined to determine whether any of the devices in the list is unavailable. If so, these devices are deleted from the list, and the edited list of available options is played to the incoming caller via an IVR (block 916). These options can include, for example, calling the user on a temporary or home phone, sending a text message to the user, or leaving the user a voice mail. Accordingly, the system collects the incoming caller's selection (block 918) and directs the call in a manner corresponding to the selection (blocks 920, 922 and 924).

For the case where the incoming caller selects ringing another phone (e.g. the user's home phone or temporary phone), the system may further determine whether the user has configured any further options in the event that that phone is not answered (e.g. within a predetermined number of rings). If so (determined in block 926), processing returns to block 912, otherwise processing ends. It should be noted that the other selected phone may have a voice mail system or cell phone operator that may pick up the phone itself after a predetermined number of rings. In that event, the phone is considered answered in block 912, and the presence system performs no further processing. It should be further noted that no additional processing may be performed if the another phone is not answered.

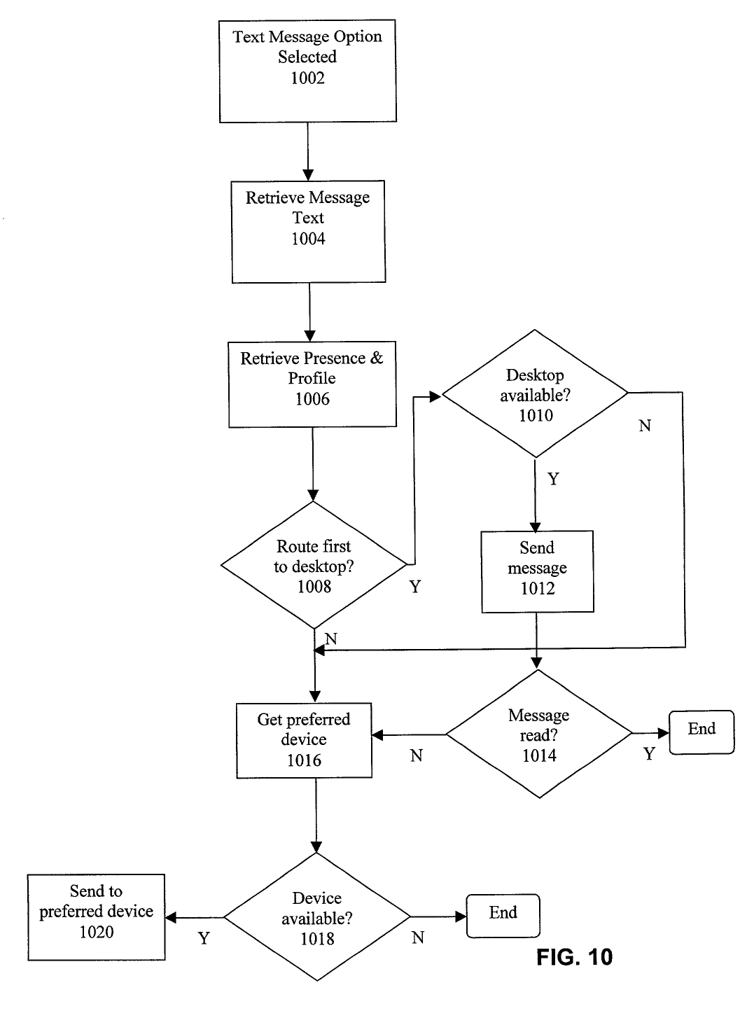

FIG. 10 is a flowchart illustrating an example method of forwarding a text message to a user based on the user's presence information and device availability as performed by a presence system 112 in accordance with another embodiment of the present invention.

As shown in FIG. 10, in block 1002 the presence system is notified that an incoming caller wishes to leave a text message for the user. This can be done in response to a list of options presented to the incoming caller such as in block 916 in FIG. 9. Accordingly, in block 1004, the text for the message to be sent to the user is collected. In one example of the invention, this is done by causing the IVR 214 to allow the incoming caller to select from one of a number of predetermined or “canned” messages such as “call me,” “meeting started,” “meeting delayed,” etc. The IVR may be further configured to allow certain or all of these messages to be appended with numeric information (since callers almost universally will be able to enter numbers via a phone keypad). For example, the “call me” message can be appended with the caller's phone number. The IVR 214 provides the messaging application 210 with the caller's message selection and any appended message information.

In block 1006, the user's current presence state is determined, and the user's context profile corresponding to the user's current presence state is retrieved. If the user's context profile indicates that the text message in the user's current presence context is first directed to the user's desktop PC (determined in block 1008), processing advances to block 1010 where it is further determined whether the user's desktop PC is available (for example, whether the PC is connected to the presence system via the network). If so, the text message is sent to that PC (block 1012). If the message is acknowledged (determined in block 1014), or if the user has not configured any other text messaging options for this presence context, no further processing is performed. If the message is not acknowledged, or if the user has configured the context such that the user's desktop PC is not immediately attempted for a text message, or if the user's desktop PC was selected for immediate delivery of text but was not available, processing advances to block 1016, where the user's preferred non-desktop PC device for receiving text messages in this context is determined (if any). This device can include, for example, a pager, or a SMS-capable cell phone or PDA. The user's profile information is further examined to determine whether the preferred device is presently available (block 1018). If so, the system prepares the text message for the appropriate device and sends it (block 1020). Otherwise, further processing ends.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

What is claimed is:

1. A method for managing communications with a user in a communication system, the method comprising the steps of:
maintaining presence information for the user, the presence information specifying one of a plurality of presence contexts;
maintaining a presence context profile for the user, the presence context profile specifying a plurality of communication options for the plurality of presence contexts; and
controlling communications with the user in accordance with the maintained presence information and the maintained presence context profile.

2. A method according to claim 1, further comprising the step of:
maintaining device availability information for the user, the controlling step being performed in further accordance with the maintained device availability information.

3. A method according to claim 1, wherein the communications include both telephone calls and text messages.

4. A method according to claim 3, wherein the communication options include a plurality of phone devices for receiving the telephone calls and a plurality of text devices for receiving the text messages.

5. A method of managing communications with a user in a communication system, the method comprising the steps of:
receiving an incoming call to the user;
determining a current presence context of the user;
determining a context profile corresponding to the current presence context for the user, the context profile specifying a plurality of communication options for the current presence context; and
forwarding a communication associated with the incoming call to the user in accordance with the context profile.

6. A method according to claim 5, further comprising the step of:
presenting certain of the communication options to a caller associated with the incoming call, wherein the forwarding step is performed in further accordance with a selection by the caller among the certain communication options.

7. A method according to claim 6, wherein one of the communication options includes ringing a phone associated with the user, the method further comprising the steps of:
causing the incoming call to be directed, before the presenting step is performed, to the phone; and
canceling the presenting step if the incoming call is answered.

8. A method according to claim 7, wherein the communication system is comprised of a PBX and the phone is part of the PBX.

9. A method according to claim 7, wherein the communication system is comprised of a PBX and the phone is coupled to the PBX by the PSTN.

10. A method according to claim 5, wherein the incoming call is a phone call to a first phone associated with the user in the communication system, the forwarding step including the steps of:
retrieving information concerning a second phone associated with the user from the determined context profile; and
causing the incoming call to be directed to the second phone instead of the first phone.

11. A method according to claim 10, wherein the communication system is comprised of a PBX and the first and second phones are both part of the PBX.

12. A method according to claim 10, wherein the communication system is comprised of a PBX, the first phone being part of the PBX and the second phone being coupled to the PBX by the PSTN.

13. A method according to claim 5, further comprising the step of:
determining a device availability corresponding to the plurality of communication options, wherein the forwarding step is performed in further accordance with the determined device availability.

14. A method according to claim 5, wherein the step of determining the current presence context comprises the steps of:
storing presence information associated with the user;
receiving a notification of a change of a presence context of the user; and
updating the stored presence information in accordance with the received notification.

15. A method according to claim 5, wherein the incoming call is a phone call to a first phone associated with the user in the communication system, the forwarding step including the steps of:
retrieving information concerning a text mess aging device associated with the user from the determined context profile;
retrieving a text message associated with the incoming call; and
causing the text message to be sent to the text messaging device.

16. A method according to claim 15, wherein the communication system is comprised of a PBX and the first phone is part of the PBX.

17. A method according to claim 16, wherein the step of causing the text message to be sent to the text messaging device includes the step of communicating with a wireless operator associated with the text messaging device.

18. An apparatus for managing communications with a user in a communication system, the apparatus comprising:
means for maintaining presence information for the user, the presence information specifying one of a plurality of presence contexts;
means for maintaining a presence context profile for the user, the presence context profile specifying a plurality of communication options for the plurality of presence contexts; and
means for controlling communications with the user in accordance with the maintained presence information and the maintained presence context profile.

19. An apparatus according to claim 18, further comprising:
means for maintaining device availability information for the user, the controlling means being operative in further accordance with the maintained device availability information.

20. An apparatus according to claim 18, wherein the communications include both telephone calls and text messages.

21. An apparatus according to claim 20, wherein the communication options include a plurality of phone devices for receiving the telephone calls and a plurality of wireless devices for receiving the text messages.

22. An apparatus for managing communications with a user in a communication system, the apparatus comprising:
means for receiving an incoming call to the user;
means for determining a current presence context of the user;
means for determining a context profile corresponding to the current presence context for the user, the context profile specifying a plurality of communication options for the current presence context; and
means for forwarding a communication associated with the incoming call to the user in accordance with the context profile.

23. An apparatus according to claim 22, further comprising:
means for presenting certain of the communication options to a caller associated with the incoming call, wherein the forwarding means is operative in further accordance with a selection by the caller among the certain communication options.

24. An apparatus according to claim 23, wherein one of the communication options includes ringing a phone associated with the user, the apparatus further comprising:
means for directing the call, before the presenting means is operative, to the phone; and
means for canceling operation of the presenting means if the call is answered.

25. An apparatus according to claim 24, wherein the communication system is comprised of a PBX and the phone is part of the PBX.

26. An apparatus according to claim 24, wherein the communication system is comprised of a PBX and the phone is coupled to the PBX by the PSTN.

27. An apparatus according to claim 22, wherein the incoming call is a phone call to a first phone associated with the user in the communication system, the forwarding means including:
means for retrieving information concerning a second phone associated with the user from the determined context profile; and
means for causing the incoming call to be directed to the second phone instead of the first phone.

28. An apparatus according to claim 27, wherein the communication system is comprised of a PBX and the first and second phones are both part of the PBX.

29. An apparatus according to claim 27, wherein the communication system is comprised of a PBX, the first phones being part of the PBX and the second phone being coupled to the PBX by the PSTN.

30. An apparatus according to claim 22, further comprising:
means for determining a device availability corresponding to the plurality of communication options, wherein the forwarding means is operative in further accordance with the determined device availability.

31. An apparatus according to claim 22, wherein the means for determining the current presence context comprises:
means for storing presence information associated with the user;
means for receiving a notification of a change of a presence context of the user; and
means for updating the stored presence information in accordance with the received notification.

32. An apparatus according to claim 22, wherein the incoming call is a phone call to a first phone associated with the user in the communication system, the forwarding means including:
means for retrieving information concerning a text messaging device associated with the user from the determined context profile;
means for retrieving a text message associated with the incoming call; and
means for causing the text message to be sent to the text messaging device.

33. An apparatus according to claim 32, wherein the communication system is comprised of a PBX and the first phone is part of the PBX.

34. An apparatus according to claim 33, wherein the means for causing the text message to be sent to the text messaging device includes means for communicating with a wireless operator associated with the text messaging device.

35. An apparatus for managing communications with users based on presence information, comprising:
a communication system adapted to provide communications among a plurality of communication devices; and
a presence system adapted to be coupled to the communication system, the presence system maintaining a presence context and a context profile for certain users associated with the plurality of communication devices, the presence system causing the communication system to direct incoming calls to the certain users in accordance with the maintained presence context and context profile.

36. An apparatus according to claim 35, wherein the communication system comprises a PBX and the communication devices comprise PBX phones.

37. An apparatus according to claim 36, wherein the presence system is adapted to cause the PBX to forward incoming calls to the PBX phones associated with the certain users to PSTN phones outside the PBX in accordance with the context profile.

38. An apparatus according to claim 35, wherein the presence system is further adapted to be coupled to a router, the presence system causing text messages associated with the incoming calls to be forwarded to wireless devices different than the communication devices associated with the certain users in accordance with the maintained presence context and context profile.
